(19) United States
(12) Patent Application Publication
(10) Pub. No.: US 2016/0012368 A1
(43) Pub. Date: Jan. 14, 2016

(54) Real-Time User Interface for Prioritized Professional Work Queue

(71) Applicants: Courtney O'Connell, San Francisco, CA (US); Liana Lawrance, San Francisco, CA (US); Vrushali Paunikar, San Francisco, CA (US); Karim Maguid, San Francisco, CA (US)

(72) Inventors: Courtney O'Connell, San Francisco, CA (US); Liana Lawrance, San Francisco, CA (US); Vrushali Paunikar, San Francisco, CA (US); Karim Maguid, San Francisco, CA (US)

(73) Assignee: ROCKET LAWYER INCORPORATED, San Francisco, CA (US)

(21) Appl. No.: 14/331,032

(22) Filed: Jul. 14, 2014

(51) Int. Cl. G06Q 10/06; G06F 3/0484; G06F 3/0481; G06F 3/0482

(52) U.S. Cl. CPC G06Q 10/06316; G06F 3/0482; G06F 3/04842; G06F 3/04817

(57) ABSTRACT

A computer, database, server and network system create, manage and change a user interface displaying a task board comprising a plurality of category columns. Each category column may display a plurality of task cards with each task card displaying task related information that may include client name, subject matter, task name, questions asked, answers issued and visual stimuli regarding task urgency. The task cards or other display areas may comprise plurality of visual cues or other graphics persuading a worker to complete tasks in an order and timeframe acceptable to the system operators and system customers.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to electronic displays and user interfaces. More particularly, the invention relates to the display of visual stimuli conveying task deadline urgency.

(2) Description of the Related Art

General “to do” lists, task lists and calendaring systems are known in the related art. While the related art provides reliable means of tracking, transmitting and displaying linear and static task lists, the related art fails to inspire worker discipline, focus or productivity on a real-time basis. The related art presents task lists with monotony and not urgency.

With the popularity of video games and other electronic media many modern workers have developed shortened attention spans. With the popularity of instant electronic communications, many modern workers are frequently distracted from completing work tasks requiring long periods of sustained thought and effort. Thus, the prior art of static task lists fails to persuade modern workers to complete tasks on a timely basis.

### BRIEF SUMMARY OF THE INVENTION

The present invention overcomes shortfalls in the related art by presenting unique user interfaces, changing task boards, task board columns, task cards, timer displays and priority displays as well as novel databases, database uses, server systems, networks and other components.

The disclosed embodiments overcome shortfalls in the art by presenting user interfaces and display systems that change in real time to comport with changing task priorities, task attributes and customer requirements. The changing or dynamic nature of the disclosed display systems and other user interfaces is in sharp contrast to the prior art systems of presenting static task lists.

The disclosed embodiments overcome shortfalls in the art by providing visual stimulation that is competitive to the constant visual distractions faced my many workers. For example, many workers are distracted by incoming electronic communications which may include hyperlinks or gateways to further distractions. A worker may easily lose significant work time while following electronic communications unless their attention is artfully and meaningfully pulled back to the work tasks at hand. The disclosed user interfaces present screen view changes to recapture the attention of a distracted worker. Often, changes in a screen view or user interface are required to recapture the attention of a worker. The screen changes are meaningful and capture the curiosity of a worker as the screen changes are triggered by real time task related factors.

In addition to refocusing distracted workers, the disclosed embodiments overcome shortfalls in the art by providing workers with changing, real time task priority information so that a worker may work on the correct project at the correct time. The disclosed embodiments automate the display of priority information such that a worker my focus on performing work and not figuring out what work to address.

To compete with outside distractions and to effectively communicate the changing realities of a task and/or pending deadlines, disclosed embodiments include the display of moving task cards, task card color changes, animated countdown timers and other user interface or display attributes.

To further focus and motivate workers, disclosed embodiments include the use of worker review systems, customer satisfaction surveys and other components to map worker timeliness and quality to external reward systems.

The disclosed embodiments include a changing or dynamic task board which may comprise a plurality of columns. A first column may display new matters or new tasks. A second column may display working matters or work in progress. A third column may display completed tasks. A task or job may be displayed in the form of a task card which may comprise the display of task data such as task subject matter, customer information, accept or reject the task radio buttons, date of task acceptance, deadline date and animated or real-time count down timers other visual components.

A third column of completed tasks provides intrinsic worker reward as completed tasks may be reviewed and collected. Completed task may be viewed as points earned in a video game and further encourage a worker to complete more tasks.

### BRIEF DESCRIPTION OF THE DRAWINGS

FIG. 1 depicts a user interface used for initial input from prospective system customers

FIG. 2A depicts a disclosed task board user interface

FIG. 2B depicts a disclosed task board user interface

FIG. 2C depicts a disclosed task board user interface

FIG. 2D depicts a question and answer user interface

FIG. 2E depicts a question and answer user interface

FIG. 2F depicts a question and answer user interface

FIG. 2G depicts a disclosed task board user interface

FIG. 2H depicts a disclosed task board user interface

FIG. 3 depicts disclosed system components

FIG. 4A depicts a flow chart

FIG. 4B depicts a flow chart

### REFERENCE NUMERALS IN THE DRAWINGS

101 interface to accept a question
102 interface to accept a geographic location
103 interface to accept user information
104 interface to accept subject matter information from a customer
105 interface to cause the screen view to continue to a next interface
201 column of new tasks
202 column of working or work in progress tasks or tasks in progress
203 column of completed tasks
205 call to action
206 interface to accept
207 interface to reject
208 real time countdown timer or priority information
209 task card
210 call to action interface
211 real time timer regarding time left to complete a task
212 a completed task
213 continue radio button within a reply to question interface
214 decline radio button within a reply to question interface
215 real time timer regarding time to answer a customer question
216 user interface for a worker or fulfiller to reply to a question
217 “continue” radio button within a reply to question interface
218 “decline” radio button within a reply to question interface
219 interface to reply to a question
220 interface to make additional recommendations
221 timer upon response interface
222 decline radio button
223 continue radio button
224 timer or fuse box timer
225 interface to reply to a question
226 make additional recommendations interface
227 interface to suggest a customer selection
228 interface showing a customer question presented to a worker
229 interface to accept or reject a task
230 task accepted
231 task rejected
232 conflict of interest interface
233 no conflict interface
234 conflict interface
301 customer or client browser/display system
302 worker, fulfiller or client browser/display system
303 front end resources or system hardware and software
204 web services or system hardware and software
305 allocation engine
306 business logic
307 customer data
308 task data
309 worker or fulfiller data
310 card assignment data
311 fulfillment work data
312 comments and feedback data
401 record customer task
402 identify potential fulfillers or workers
403 assign, create fulfillment cards
404 collect fulfillment work
405 logic decision point, task fulfilled 1 plus times ?
406 submit task history for review
407 set initial status
408 all work required to proceed from this status complete ?
409 final key state?
410 done (feedback optional)
411 present calls to action on card based on card's current key status and other state
412 fulfiller or worker address a call to action
413 action includes fulfillment work?
414 save fulfillment work data
415 action changes card date, key or otherwise?
416 card state change

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

Additional Prior Art

The Internet has seen the development of businesses and business methods designed around the assignment and outsourcing of discrete work projects to professionals using an intermediary service as a broker or facilitator of communications. Examples of other companies working in various fields include Angie's List (contractors), oDesk (contractors and outsourcing), TaskRabbit (miscellaneous tasks), Uber and Lyft (personal transportation). Most of these services receive tasks from one set of users (customers) and allocate them to other users (fulfillers) for fulfillment. Some form of interface is generally provided for fulfillers to keep track of the tasks assigned to them, often simple lists or checklists, queues, or in the case of larger projects, timesheets and programs for tracking the number of hours spent working on fulfillment.

Disclosed Embodiments

Disclosed embodiments include a system including a user interface for task fulfillers or workers in the form of a “task board”, listing a fulfiller's or worker's assigned tasks in an order of weighted priority. The interface presents tasks as one or more lists of “cards” that detail critical information regarding the nature of a task as an ordering based on priority. In the simplest case, priority is presented as urgency based on elapsed or remaining time. The presentation of assigned tasks in this manner impresses upon the fulfiller the need or desirability to address the time criticality of tasks, optionally reflected in the fulfiller's or worker's ratings, reviews, or rewards, tangible or intangible, for fulfilling said tasks.

Disclosed embodiments encourage the workers or fulfillers to complete tasks assigned to them in a priority determined by the system and presents the fulfillers with a means by which to see clearly which tasks they have completed.

Disclosed embodiments are not limited to the legal field and may be applied upon a user interface and/or computer system.

Disclosed embodiments overcome shortfalls in the art by improving the quality of service provided to customers in a disturbed work system. In prepaid legal plan or similar system, in maintaining service level agreements and quality of service for customers, it is vital to communicate to the workers of fulfillers the requirements and relative priority of the various tasks assigned to them. Simple task lists, especially those that are simple queues or provide a relatively static representation, present monotony instead of urgency, providing few visual cues that command the fulfiller's attention or provide a limited sense of satisfaction in their completion or progression, with most incentives and rewards provided outside the context of the user interface. In comparison, the effective presentation of information promoted by this disclosure and the identification of crucial information such as time constraints facilitates this by drawing attention to those priorities; the presentation of real-time prioritization information (such as animated or real-time countdown timers), as well as the visual stimulation provided by the movement of cards and/or changes in color that accompany progressive fulfillment, helps keep fulfillers actively engaged in attending to their assigned tasks and contributes to the sense of satisfaction derived from the making of progress.

Disclosed embodiments are directed toward the provision and enablement of such service provision and fulfillment in real-time, over the Internet that improves the availability, accessibility, and affordability of said services to customers. This disclosure is further directed towards improving the responsiveness and real-time reliability of services by providing visual and psychological feedback to the workers and fulfillers.

The present disclosure comprises a computer method and system for assigning or allocating professional work tasks from one or more customers to be completed by one or more workers fulfillers in real time. A disclosed system provides an interface over a communications network, such as the Internet or a private intranet, by which tasks are displayed with priority information indicating relative urgency or importance to workers or fulfillers who are given the opportunity to complete tasks. Task urgency may be based on elapsed or remaining time from the date and time of submission. The presentation of assigned tasks impresses upon the worker of fulfiller the need or desirability to address the tasks in real-time, optionally reflected in ratings, reviews, or rewards to the fulfiller, tangible or intangible, for their fulfillment.

One of skill in the art will appreciate that although an embodiment of the invention described herein is made with reference to a system designed to operate over the Internet, served by a host system designed to be accessible over the World Wide Web (“WWW”) by way of Uniform Resource Locators (“URL”) via Hypertext Transfer Protocol (“HTML”), disclosed embodiments may be designed to be deployed over one or more network architectures, including private Intranets, mobile devices over wireless communications, through tablets and smartphones, via e-mail deliver, or any network-connected device using the appropriate rendering devices, browsers, and served by appropriate data stores.

An embodiment of the present invention provides a method and system enabling customers or potential clients to submit tasks for completion to a host service via a client interface, whereupon the host service allocates a task to one or more potential fulfillers or workers. The fulfillers or workers access the host service through another client interface to view the tasks assigned to them. As workers or fulfillers complete tasks, the fulfillers' or workers' client interface visually represents changes in task state through position, placement, arrangement, color, interactive calls to action, or other indicia to represent progress toward completion. These visual cues provide visual stimulation that draw a fulfiller's or worker's attention both the relative priority and urgency of the assigned tasks as well as their progress toward completion in ways that command the fulfiller's attention and provide a progressive sense of satisfaction in their completion. Disclosed embodiments present a configuration of cards, actions, information and other components in the context of discrete legal tasks or other tasks requested by customers being allocated to one or more legal professionals or other workers for fulfillment within an amount of time established by the parameters of the services offered.

The term “task” may mean a data and visual representation of a real-world job, task, or service request. Different types of tasks can be created by the actions of different types of users, or, potentially, created as side effects from the completion of other tasks or the meeting of other conditions as defined by the system (including events such as system requests, receipt of feedback, timed or time-delayed programmatic triggers, and the like)

Data associated with tasks is maintained in the data storage part of the architecture/stack. Some of this data is presented as “cards” or task cards so the information is communicated via the architecture from the data store to output/display devices for interaction by a worker or fulfiller. Information relating to tasks may be modified by various means and actions, and such changes may be communicated internally within the architecture or in response to actions by customers or fulfillers/workers.

The term “customer” may mean user with whom the service associates identifying and account information, and who may issue certain types of tasks for completion by fulfillers or workers.

Customer data may be maintained in the data storage part of the architecture/stack. Some of this data may be presented with associated tasks on “cards” or task cards so the information is sent via the architecture from the data store to output/display devices of the fulfillers or workers.

The terms “fulfiller” and “worker” are used interchangeably and may mean a user with whom the service also associates identifying and account information, and who may be assigned the responsibility or opportunity to complete various customer or system issued tasks.

The term “call to action” may mean an interface element or other means of issuing commands (i.e. icons, buttons, hyperlinks, forms, interactive elements, voice or touch commands, possibly an entire Card in a touchscreen drag/drop fashion and other means), which generate a request message to the system backend and/or frontend logic to indicate a desire to accomplish or set in motion certain events and changes in state with respect to tasks, user data, other underlying data, or any other system tasks necessary to effectuate any services, notices, messages, presentations and the like to be displayed, reflected, recorded, or stored by the system.

Calls to action may be implemented on the frontend/end user side with HTML, jQuery, Angular, CSS, JavaScript, or similar technologies appropriate to the output device and involve some degree of interactivity. When activated by the end-user, they can have a variety of effects, but anything that changes the actual state of any associated data (a card, a task, end user profile data and others) generally involves communicating information (a ‘request’ for state changes or other results) from the user-facing client to the backend. State changes to stored data and responsive information for display on the user-facing client can both result.

The term “display” may mean any data representation device (screen, terminal, browser, braille reader, text-to-speech or other system) used to convey information to an end user, including client-based software needed for delivery such as browsers or operating systems.

The term “card” or “task card” may mean the graphical, visual, or media representation of a Task as displayed via a browser or other output device. A card may depict any information, graphically, visually, or otherwise, appropriate to the context and design of the system, including but not limited to, any set or subset of the following elements regarding its associated task: 1) creator information, 2) priority information, 3) task type information, 4) calls to action, 5) status information (in a disclosed embodiment, a description of “progress” to completion), and 6) feedback information.

Cards or task cards may comprise data objects stored upon the data storage part of the architecture/stack, communicated to the end user via the display. Once displayed, they and their surrounding interface may include one or more calls to action, as appropriate.

The term “priority information” may mean Information relating to the priority preferences associated with a given task, allowing the assigned worker(s) or fulfiller(s) to determine the priority ordering of tasks relative to each other as displayed on one or more cards. In an example embodiment, priority information may be conveyed as a countdown timer reflecting the amount of time left to fulfill a task. Possible representations include a color-coded fuse box style visual.

The exact nature of the priority information depends on the application and context, and priority information for a given task or card may be concrete data stored in the data storage part of the architecture or derived information that is extrapolated or calculated in software. In an example embodiment, priority information includes a colored fuse box graphic that shows a countdown of the time remaining to address a task, reflecting a growing urgency for fulfillment as time passes while the task remains incomplete.

The term “task type information” may mean information relating to the nature of a Task, including its type or classification and relevant categorization information, if any. In an example embodiment, the tasks may be orders or requests for specific work of a legal nature, for instance a “question”, “document review”, “consultation”, or a “follow-up” communication relating to another, previous task or concern. Such tasks may further be divided into specific sub-disciplines, such as trademarks, copyrights, commercial contracts, or tax law.

The term “status information” may include information relating to the present state of progress or completion of a given task. Such information may be numerical, descriptive text or word labels. In an example embodiment, for example, there can be three possible visible “states” for a task: “New”, “Working”, and “Completed”, and “Rejected”, a fourth state relevant to the data representation but not displayed on the interface (“key status information”). Secondary status information may optionally be present or represented on the card as well, depending upon the context. Such secondary status information, if any, may or may not have a task board “column” or “row” element dedicated to reflecting it. In a sample embodiment, secondary status information may include clearance, consent, or conflict information that ‘clickwraps’ a task or issue.

The term “allocation” may mean the assignment of a task to one or more fulfillers or workers. An allocation may be based upon, inter alia, system parameters, task types and fulfiller/worker characteristics as described in user data. A fulfiller/worker facing interface presents cards associated with the tasks assigned to the fulfiller or worker. In an example embodiment, a fulfiller/worker only sees cards that have been specifically assigned to the fulfiller/worker.

### TECHNICAL BACKGROUND

Disclosed systems may be embodied by an internet and mobile device available hosted service, with user data, commands and actions, display and rendering being implemented on remotely hosted servers and computing resources may use standard Internet communications protocols as well as web development frameworks and network architecture stacks. Specific technologies include Rackspace for remote hosting, HBase and Percona MySQL for data storage, RabbitMQ and protobuf for messaging, Java EE and Spring for services development, and HTML, jQuery, Angular, CSS, and JavaScript for display and page rendering.

Further Description

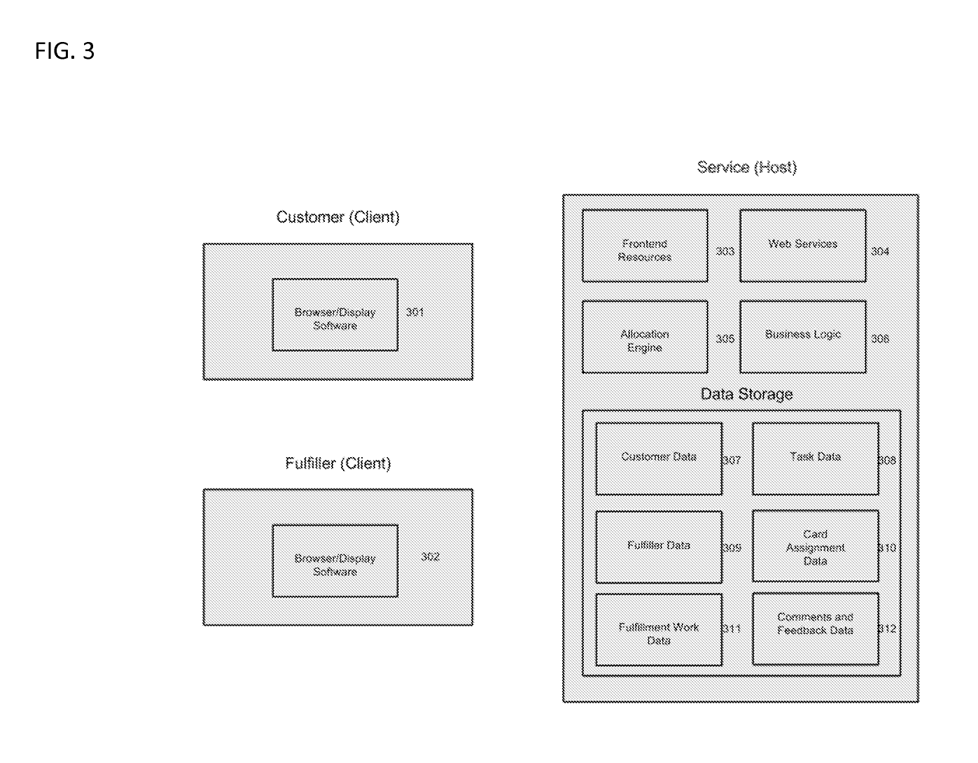

An embodiment and possible configuration of this system is depicted in FIG. 3. Customer data 307 may be uniquely associated with individual customers and stored in the server system's data storage. Worker or fulfiller data 309 may be uniquely associated with individual workers or fulfillers and also stored in the server system's data storage. Tasks submitted to the system are recorded in the system's task data 308. Task data records characteristics of the customer's requested task, including, as appropriate, category or type of work, verbal or textual descriptions, or attached files integral to the task. As tasks are assigned to potential fulfillers for fulfillment, card assignment data 310 is generated and stored in the system, with each set of card assignment data representing the worker's or fulfiller's relationship to the assigned task and the task's current state of completion and priority information. Files, text, or other data submitted to the system by a fulfiller or worker to address an assigned task are sent by the fulfiller or worker through their client interface or other means to be stored in the system as fulfillment work data 311. Those of skill in the art will know and understand that the organization of said data can be accomplished in a number of different ways according to the needs of different data architectures, taking into account the demands of scale, security, performance, and other data storage considerations; the above system may, for example, be constructed through use of key-value stores, relational databases with dedicated tables, nonrelational storage, flat files, or other data storage and retrieval schemes. The data itself may overlap or merge depending on the system.

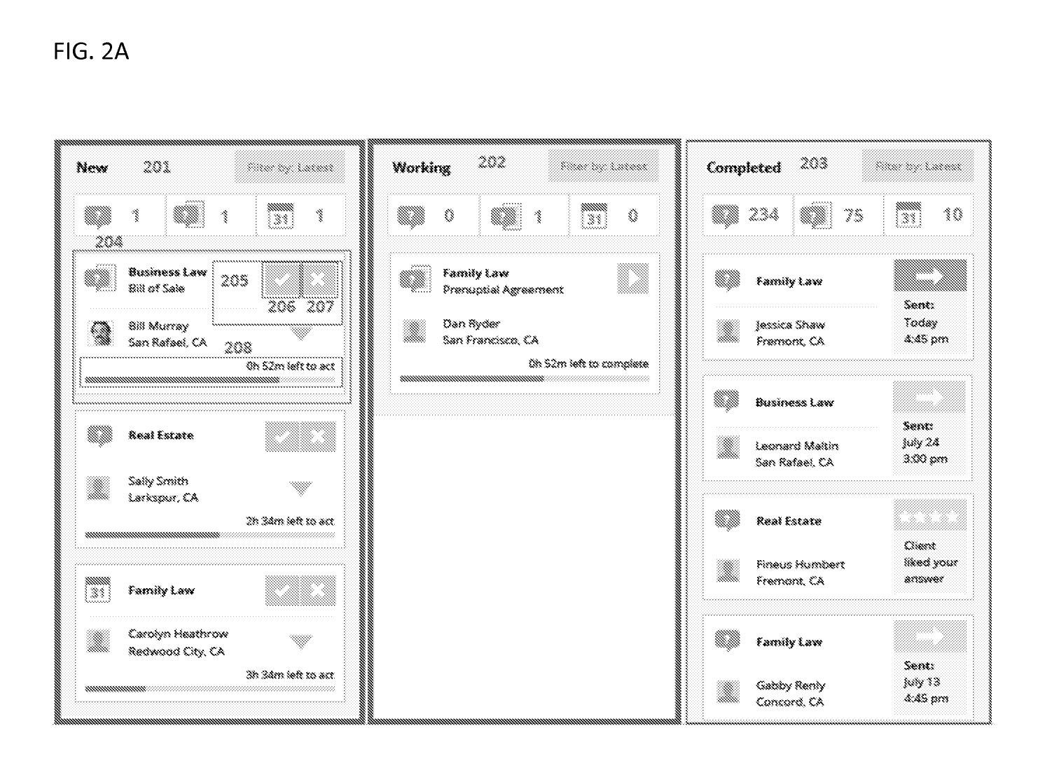

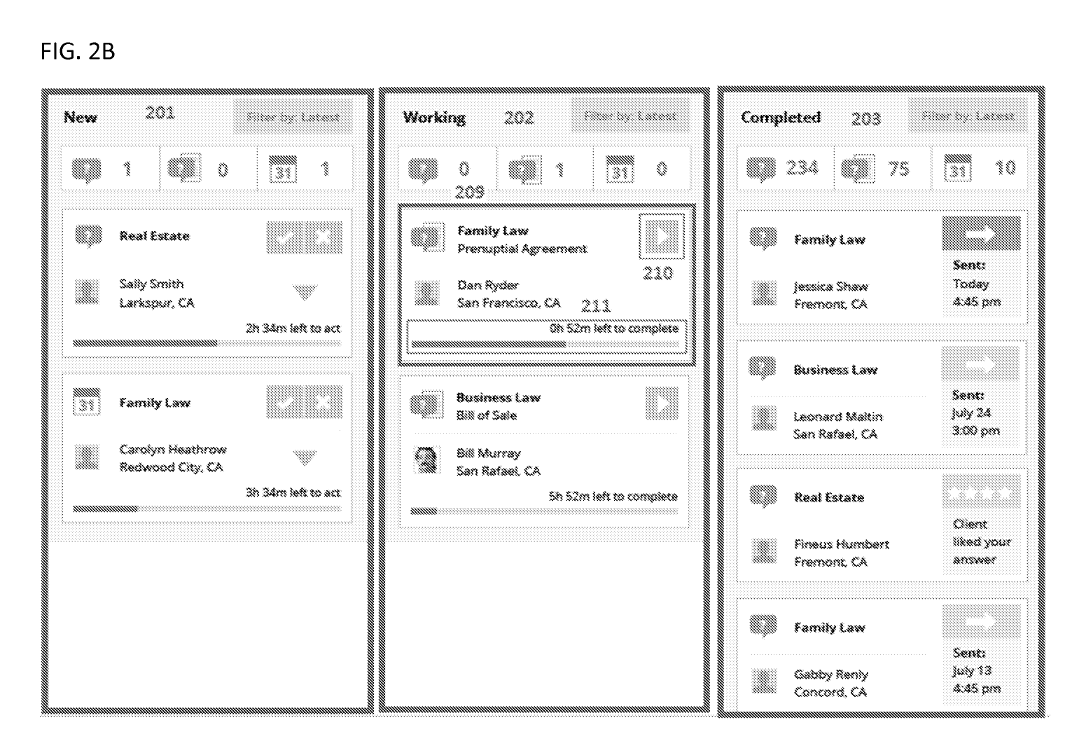

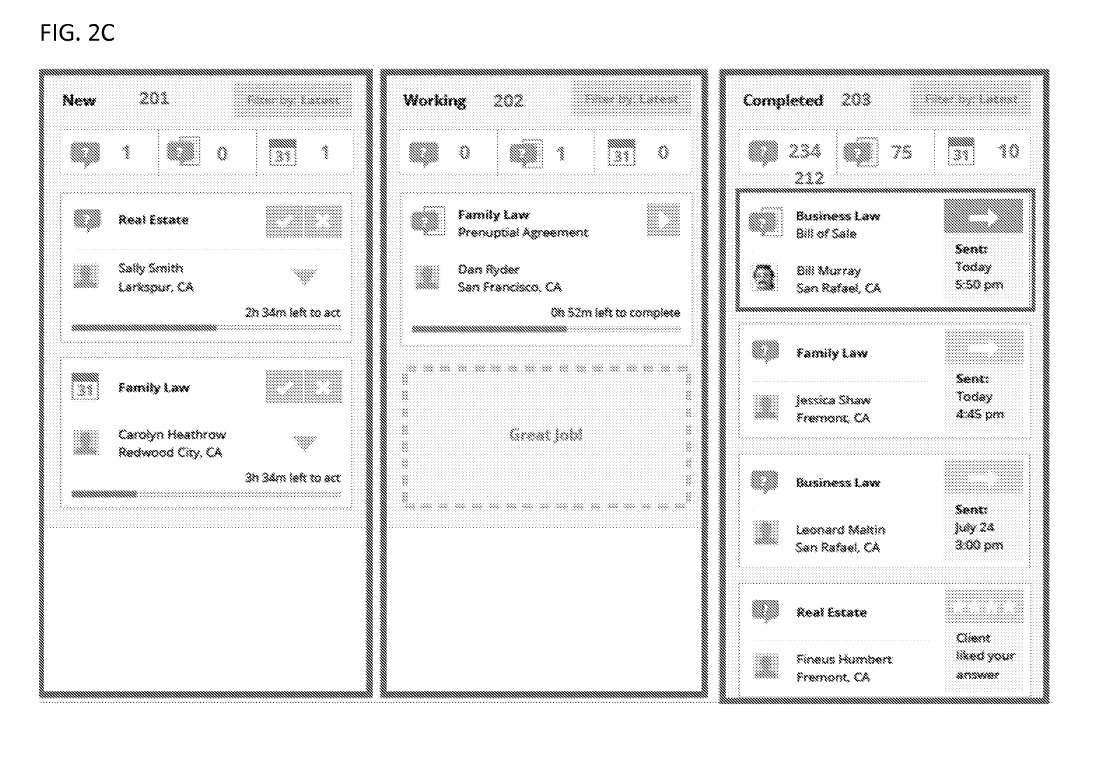

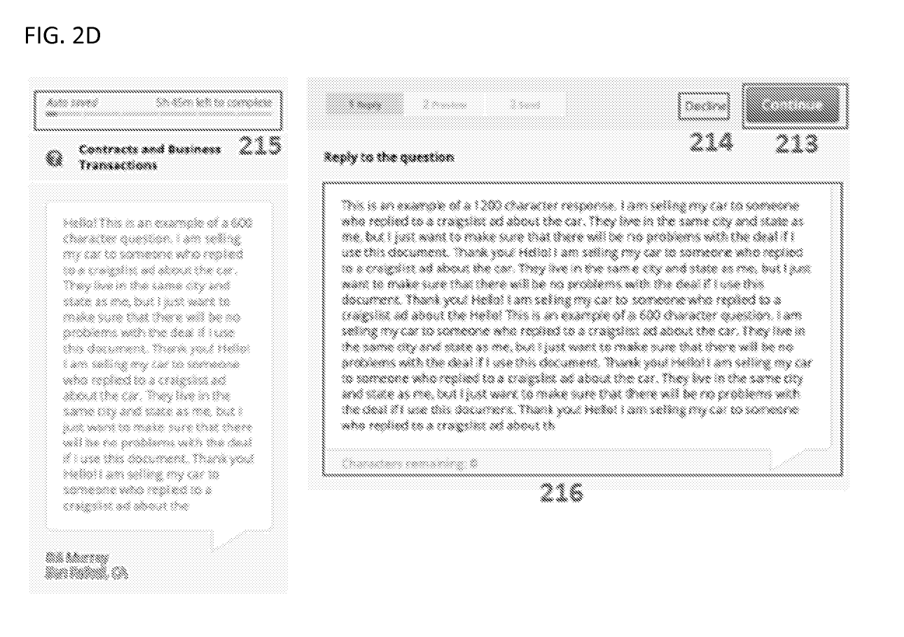

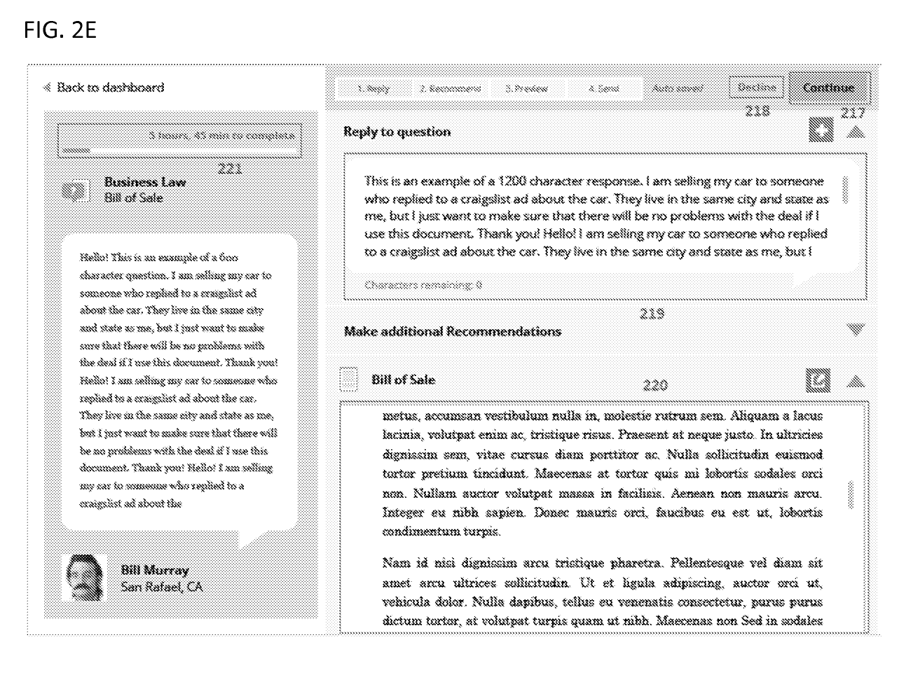

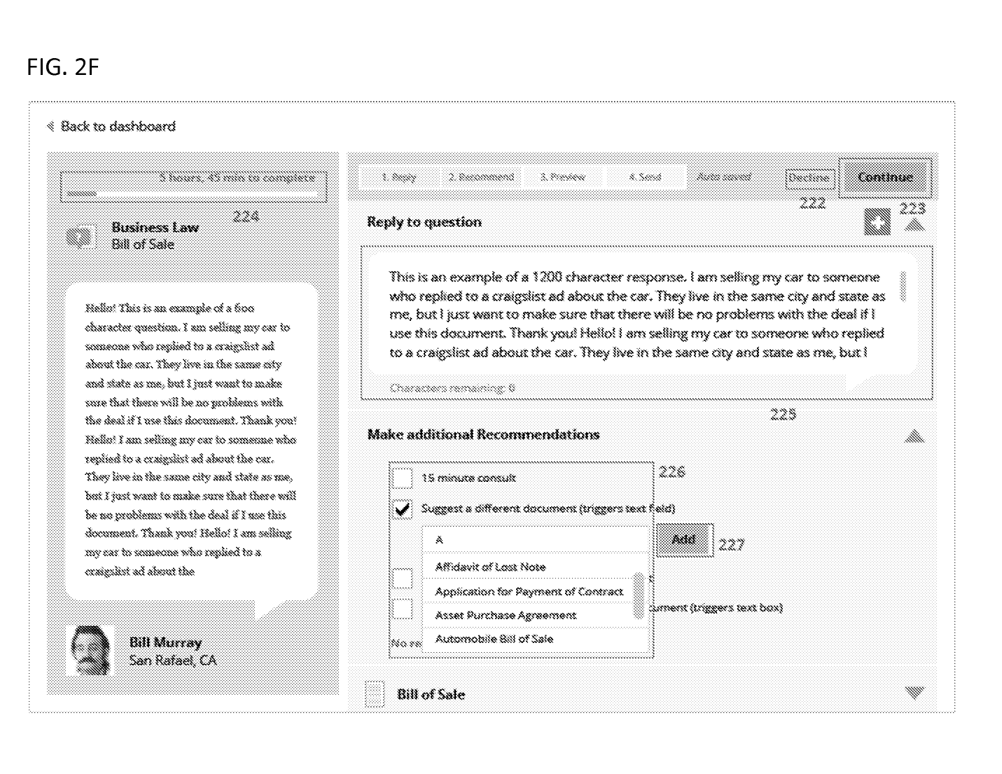

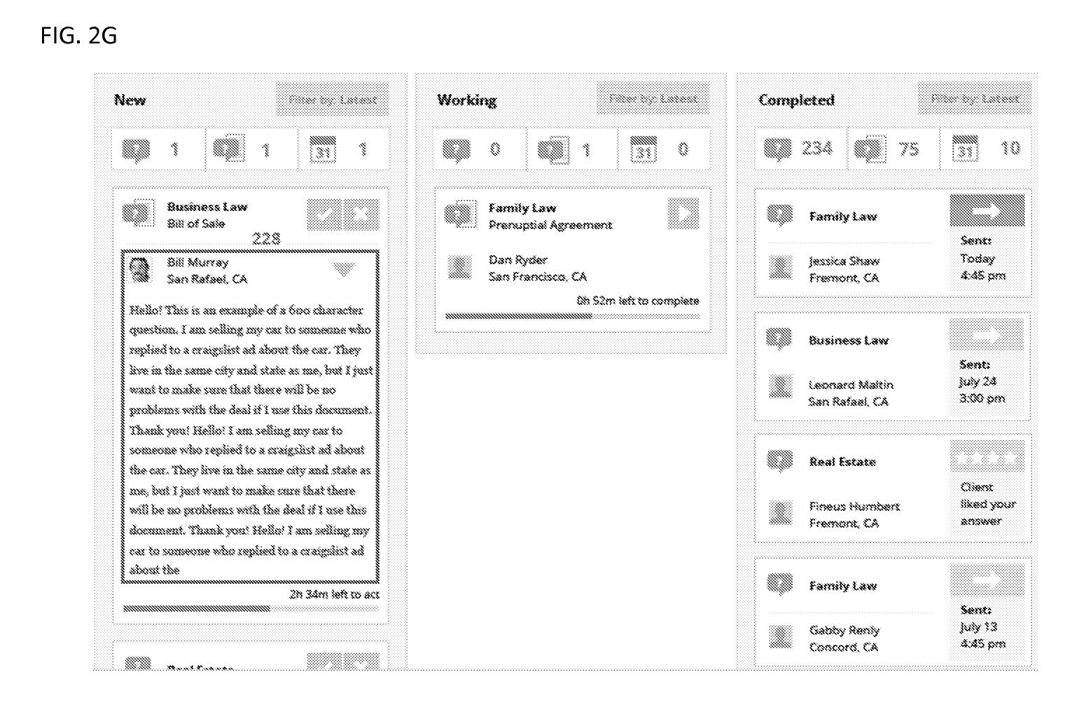

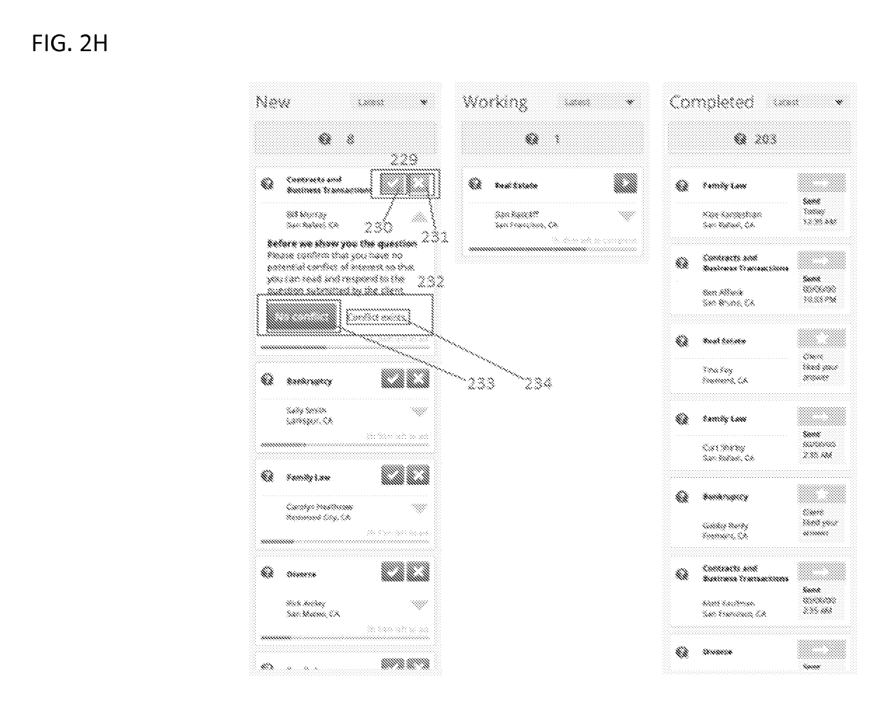

In the embodiment being described in FIG. 2, customer data 307 and fulfiller data 309 are separate, but a system where customer data and Fulfiller data are stored in the same database table with roles determined and distinguished by additional data located within that table or elsewhere would also be well within the understanding of those having skill in the art. Those of ordinary skill in the art will also understand that while the embodiment described is specifically directed at a system designed to serve customer requests for legal work to be fulfilled by licensed legal professionals, the invention itself can be adapted to address other or more general types of work in other business or fields of endeavor.

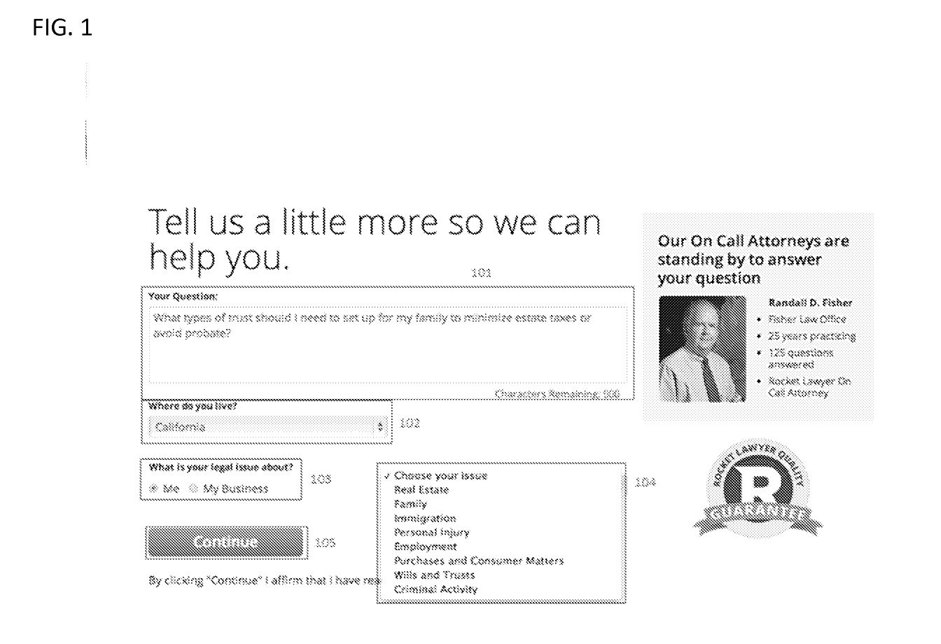

The host service, or server, may comprise computing resources, whether directly operated, remotely hosted, virtualized, or otherwise configured to serve messages, data or other content over a network. System components and/or computing resources may be configured to provide web services 304 for management of communications, including the uploading and downloading of data and other information across the network or within the system architecture, business logic routines 306 which may implement the backend implementation of a disclosed embodiment, an allocation engine 305 which is tasked with identifying potential fulfillers or workers to assign to incoming tasks, and frontend resources 303 which may include content management systems (“CMS”), content distribution networks (“CDN”), or other electronic storage and transmission systems used to general content for display to client interfaces. For example, frontend resources such as the CSS, HTML, JQuery, Angular, or other frontend display rendering templates for creating the user interfaces depicted in FIG. 1 and FIGS. 2A-2H are typically stored and maintained here, while the information used to populate these resources in rendering, such as customer, fulfiller, task, card, or work data, and located in data storage. Those of ordinary skill in the art will appreciate that data storage may be configured in various ways and that frontend resources may be located in close proximity to or even within the same system as other data as a matter of preference or design.

Display information for rendering the client interfaces is transmitted to and received by web services 304 from customers or fulfillers on their respective display devices as appropriate and authenticated by standard session identification technologies. The customer client interface 301 or fulfiller client interface 302 may comprise a display device making use of browser or display software or firmware that directs the display device itself, whether a computer terminal or monitor, smartphone, tablet, mobile reader, laptop, or other display device, to render the user interface appropriate to the user and situation.

Referring to FIG. 1 and other figures an interface 101 is presented to accept a question from a customer. The question may lead to a new task. In a disclosed embodiment, the subject task is a legal task such as review of a legal document or the answering of a legal question. The user interface illustrated is displayed via the client browser and display apparatus 301 after being created by the server and transmitted by the server as controlled by the web services 304 in conjunction with session and user data from customer data 307 and frontend resources 303.

This example shows a multi-step process and user interface elements by which a user indicates the particular legal specialty (“practice area”) 103 implicated by his request, a geographical region 102, and provides a textual description 101. These pieces of information may be offered and chosen in a variety of methods available and known to those having skill in the art, including select options, as depicted by 102, or tiered, categorized, or sub choices as depicted by practice area selection interface 103 and 104. A customer at their option and as permitted by the design of the system, attach other files or documents to the request as part of the task to be assigned. Those of ordinary skill in the art will appreciate that these elements may be combined on a single page or split across several pages, and the number of communications with the host web services will vary with the implementation. Whether incrementally or in a single message, upon submission via selection of an interface element 105, the client interface 301 will send information defining the desired task to the host service via web services 304 and the server system will store it during step 401, along with any attendant changes in the customer's account, in task data 308 and customer data 307.

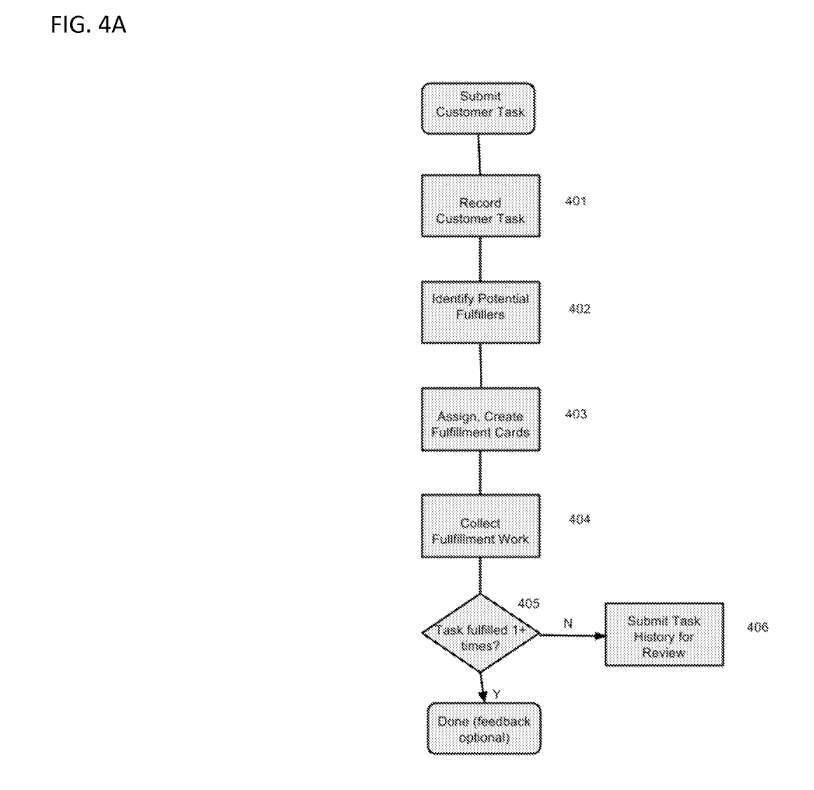

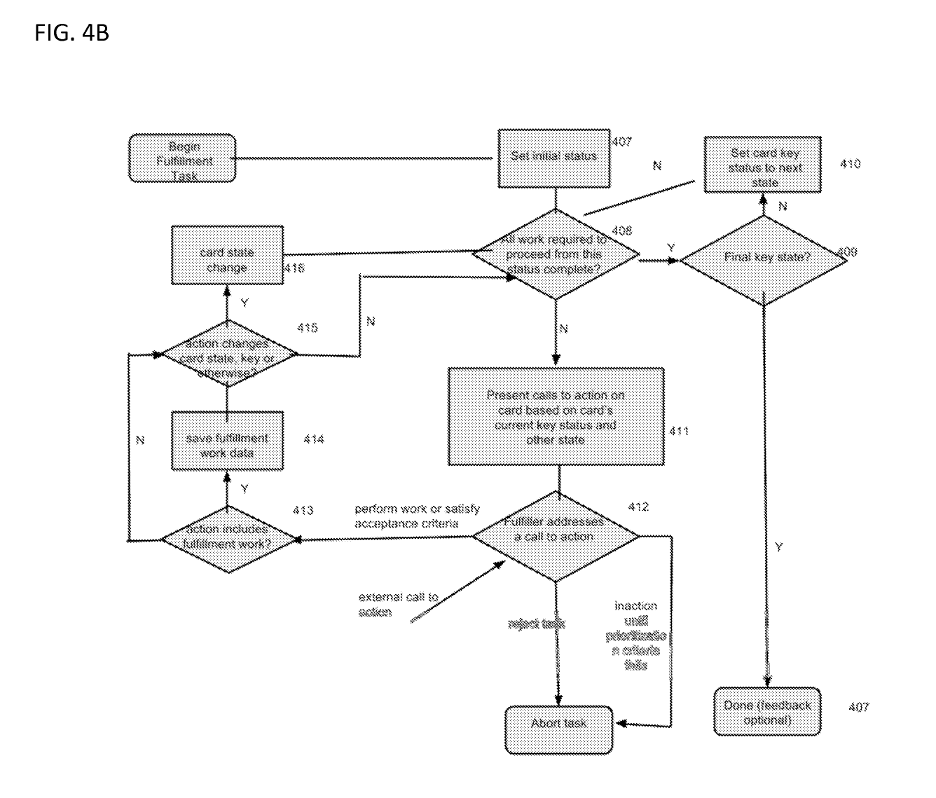

The flow diagrams in FIGS. 4A and 4B depict the workflow of task submission, assignment, and completion. On receipt of the customer task information by web services 304, the server system's business logic 306 uses an allocation engine 305, which may be implemented in software under criteria and qualifications determined by the business logic 306 and making use available data from any combination or subset of customer data 307, task data 308, fulfiller data 309, to perform step 402 and identify potential fulfillers. The system may, for example, select potential fulfillers based on criteria that consider the type of task, as recorded in the task data, matched against expertise and experience as recorded in the fulfiller data, and cross-referenced against prior feedback and performance on the system as may exist on the system in comments and feedback data 312. Such matching and querying techniques will be apparent to those of skill in the art within literature and experience with systems such as relational databases, data indexes, and data object storage schemes. Once identified by the allocation engine 305 and/or the business logic 306, the system performs step 403 by creating and recording assignment data 310 that will track the status of individual fulfillers' progress towards task completion. In the embodiment being described, fulfillers may each fulfill the work separately and individually and independently, and hence each fulfiller has a separate instance of assignment data associated with him and the assigned task. Those having skill in the art will recognize that it will, depending on the circumstances and business application, also be possible to design a service where cooperative or collective assignment and work may be implemented. The assignment data is used to help prepare data and messages from the server to the fulfiller(s) interfaces 302 for display in the user interfaces show in FIGS. 2A-C.

Step 404 in FIG. 4A is further illustrated for each fulfiller via the flow diagram in FIG. 4B and the illustrations in FIGS. 2A-F. The fulfiller-facing interface includes a presentation of tasks as “cards” which relay essential information to the prospective fulfiller, as in FIG. 2A (204). The cards are rendered by the client interface 301 in accordance with information transmitted by web services 304 created by assets and data from frontend resources 303, business logic 306, and card assignment data 310 which itself may reference other information in data storage. As designed and presented, the cards include information useful to the prospective fulfiller in identifying the nature of the task, including any set or subset of relevant information, including, but not limited to, customer or entity names, type of work or task, summaries or short descriptions, work prioritization information or cues as defined by the allocation or broker service (“priority information”), progress indicators, the customer or fulfiller's own preferences or arrangements with the server system, and available feedback or any subset thereof. The card also potentially contains calls to action (interactive elements) that allow the fulfiller to initiate work or indicate a change in disposition towards the word to be done, for example, the rejection of an inappropriate or unfulfillable task, or a willingness, commitment, or consent to completing the task or a condition required to make further progress. Visually, the cards are arranged in a display format such as “rows” or “columns” to indicate common key statuses, for example, a given or established state of completion. In the embodiment being described, these states are denoted as “New”, “Working”, or “Completed”, although when configured for a different business application, more or fewer key states may exist. In the embodiment shown, cards in the “New” and “Working” column are ordered according to priority information.

For example, an embodiment of the task board and card arrangement is shown in FIG. 2A. The cards are arranged within a “task board” viewable by individual fulfillers in a series of columns 201-203. Each column of cards corresponds to a particular key status, representing “New” (201), “Working” (202), and “Completed” (203) key states of progress or completion, and “cards” representing individual assignments of tasks associated with this fulfiller (as recorded in card assignment data 310). The cards in the “New” and “Working” columns represent unfinished tasks and as such contain priority information, in this case, a “fuse box” graphic 208 showing the time remaining to complete the task, sorted in order from most urgent/least time remaining from top to bottom, reflecting the priorities assigned by the customer and/or the service provider by way of service level agreements or price. The cards may also further display relevant representation of select customer data 307, fulfiller data 309, fulfillment work data 311, task data 308, card assignment data 310, or comments and feedback data 312 as appropriate. Each fulfiller on the system sees tasks that have been allocated to him; different fulfillers each access the system with individual credentials, such that each has a task board representative of the tasks he has the opportunity to fulfill.

In the described embodiment, the simplest form of priority information is defined as elapsed time from the time and date of submission of a given task. In an example embodiment detailing a simple system, all tasks are of equal weight and value to the fulfillers, and each needs to be completed within 24 hours according to the service level agreement with the customers. The priority information 208 is therefore depicted as a fuse-box styled visual, with time remaining to complete the task represented by a colored bar, wherein shorter bars indicate greater urgency, and wherein. Further real-time feedback is provided by an animated countdown timer. For example, a task that has just been submitted will have a fuse box with a full fuse bar, a green color, and a countdown timer listing over 23 hours and 59 minutes of time remaining for fulfillment remaining. A task that was submitted 23 and a half hours in the past would have a fuse box with a short, nearly spent bar graphic, a red color, and a timer display listing 30 minutes and counting down. While the user may be free to order and address tasks at his discretion in some implementations, the display will generally and by default ordered in such a way as to present high priority (low time remaining) tasks nearer to the “top” of the sort order. More complex or intricate priority weighting taking into account any number of additional factors is possible. The simple case above simply presents the case where priority ordering is defined by the number of seconds remaining for the fulfiller to fulfill the task and receive acknowledgement and/or credit for it, with lower numbers representing greater priority and urgency. Other schemes can add weights or scaling factors to the priority information; customers who have paid for additional priority may have heightened priority that may be represented as a division or scalar subtraction on time. Highly urgent tasks may start out with less than a 24-hour time initial time period for fulfillment. High-value or high-reward tasks may similarly be presented with a higher calculated priority as well.

As a task is submitted, recorded, and assigned as above, the card assignment data for a given fulfiller-task association is set to an appropriate key state, in this case, the “New” state as in step 407. FIG. 4B is a flow diagram that illustrates the workflow that a fulfiller engages in upon receiving a new task card on his task board. As this workflow proceeds across the available potential fulfiller or fulfillers, the activity in this flow diagram achieves steps 404 and 405. In the embodiment shown, the fulfiller sees a new ‘card’ associated with a newly submitted task as shown, for example, in FIG. 1A. One or more ordered actions is required for the fulfiller to progress such a card to a “Working” state, which would result in a visual relocation of the card to column 202 and then further to progress to the “Completed” state, which would result in further visual relocation of the card to column 203. To proceed from one column to the other, the fulfiller needs to create and save fulfillment work, indicate acceptance or assent to conditions, or both, which will vary depending on the type of task as defined in task data 308 and supporting information as well as the present state of this fulfiller's progress as recorded in 310, within his associated card assignment data for this card.

For example, the new card in FIG. 2A displays priority information 208 and call to action 205, which presents the fulfiller with a choice of either accepting (206) or rejecting (207) the new card. This corresponds with steps 407 and 408 in the workflow of FIG. 4B. This embodiment's system's business logic 306 for a card of this task type in a “New” state requires a single action to set the card's key state to “Working” and to thus be relocated to column 202 as card 209, this action being the acceptance of the work (indication of willingness to perform fulfillment work). The fulfiller and card remain at step 408 until the fulfiller interacts with the call to action 210 in order to proceed to step 412, because otherwise, the workflow proceeds from step 408 to step 411 and remains there. If the fulfiller rejects the call to action, in this case by clicking or selecting the “X” (“reject”) icon or button, the workflow is actively rejected and the card will be removed from this fulfiller's task board display, as he has indicated that he is not interested in working on this task or cannot fulfill this task. Should the fulfiller choose to actively reject the task by clicking “reject” button 207, the call to action sends a message (typically in the form of a structured URI or REST API call) from the fulfiller's interface 302 to the server's web services layer 304, which records the rejection state in at least the area of the card assignment data storage 310 that records the relationship between this specific task and this specific fulfiller. The message contains information identifying either the task and fulfiller or information directly relating to the card assignment data itself and a message or code indicating rejection. The server's web services 403 receive the message as a request and the information is processed by business logic 306 which records the necessary state changes in at least card assignment data 310. Tasks so rejected are not displayed on the task board in this embodiment in any of the task board columns, though this does not categorically exclude them from being displayed to the fulfiller in other parts of the system as part of that fulfiller's history. When next the server renders or displays the task board user interface to the fulfiller by sending the relevant card assignment data through web services 304 and frontend resources 303 to the fulfiller's client interface 302, or if the frontend display information of the task board is programmed to automatically remove from view tasks so treated, the card will not be rendered in the columns. If the fulfiller does not interact with the card's available calls to action at all, eventually the time allotted to fulfill the task as per the priority information represented in 208 will expire, and the task will be removed from the fulfiller's task board through fulfiller inaction. (Depending on the design of other parts of the system, inaction or rejection may result in other information being recorded in the system, perhaps in fulfiller data 309, card assignment data 310, or comments and feedback data 312, which may or may not be used for analysis, performance review, or as feedback for the allocation engine 305 in the future).

In the case where the fulfiller selects, interacts, or clicks (as appropriate) with the “accept” call to action 206, the system proceeds from step 412 to step 413 by sending a message from the fulfiller's interface 302 to the server's web services layer 403. Again, such a message contains information either sufficient to identify the unique task and the fulfiller relationship or the information corresponding to the card assignment data relating to the card in question and may take the form of a structured URI or a REST API call. It is conveyed from the fulfiller's client interface 302 to the server's web service layer 304 over whichever communications network is being employed by the system, and the message is parsed and analyzed by the systems business logic 306 to store any resultant changes in state in customer data 307, task data 308, fulfiller data 309, and/or card assignment data 310. In this embodiment, the business logic dictates that such a message indicates that the card so identified is to have its key state changed from “New” to “Working”. The business logic process can be followed by observing what follows from step 412 in the work flow of FIG. 4B. At step 412, the business logic receives the message and determines that it is an acceptance action, not a rejection action, and proceeds to step 413. The call to action 206 did not itself require the fulfiller to produce any work product beyond indicating acceptance, so the flow proceeds from step 413 to step 415. The system's business logic dictates that an acceptance of this kind is intended to change the key state of the indicated card from “New” to “Working”, and in step 416 the business logic directs the system to record this change in the relevant card assignment data entry within 310. The system's business logic returns to step 408, and now that the card's present key state is “Working” and not all conditions required to proceed from “Working” to “Complete” are yet complete, the server then renders the next step in the workflow from the fulfiller's perspective to the fulfiller's client interface. Upon completion of this data update, the server will send frontend information informed by context and the newly updated data to the fulfiller's client interface for rendering. Depending on system settings, design, or preferences, the system may render to the fulfiller either a task board similar to the one illustrated in FIG. 2B, which presents the visually relocated card in the “Working” column, or instead immediately render a separate fulfillment interface distinct from the task board, to encourage the fulfiller to begin immediately the work of progressing further on this task, e.g. FIG. 2D. The latter case represents a temporary detour from the task board interface, but as most fulfillment actions involve submitting messages to the same server that maintains the task board implementations, signals “external” to the task board interface can interact with the work flow of FIG. 4B at step 412 on the same technical level as calls to actions from the task board at step 411. Those of ordinary skill in the art will recognize that the nature of REST APIs and URI's in general implementation of web services means that work flows of the type depicted in FIG. 4B need not be exclusively or strictly limited to an idealized workflow.

In some embodiments, depending on the nature of the task and the business services being implemented by the system, the card state change may result in a key state that requires no further conditions to fulfill, in which case the workflow may immediately loop through steps 408, 409, and 410 back to 408, resulting in a net change through two or more key states due to one user action.

FIG. 2B illustrates a task board wherein the card above is now in the key state “Working”. Having just arrived in this state, the fulfiller has yet to perform any actual fulfillment work on the task. The card 209 representing the task currently being examined resides in column 202, reflecting its current key state, and contains a call to action 210 that invites the fulfiller to begin fulfillment work. Here, at step 412 the fulfiller may work on fulfilling the task by selecting the call to action 210 which in the described embodiment sends a message via structured URI or REST API containing a request to the server to provide information for rendering a work interface appropriate to the context of the task. In this example, FIG. 2F illustrates a possible implementation wherein the fulfiller is presented with a text entry interface suitable for answering a legal question. The message, or request, generated by the fulfiller's use of call to action 210 is sent by the client interface 302 to the server's web service layer 304, and analyzed by business logic 306, which directs the web service layer to prepare a response using relevant context from the data storage layer combined with frontend resources 303 to send information back to the client interface 302 for subsequent rendering and display. In a case where the work to be done is designed to be achievable within the interface space of the card itself, the page so rendered may be an updated task board or data to be inserted for additional rendering in the task board (e.g. by an Ajax call receiving JSON return data). In many other cases, however, the work is substantial enough such that a separate fulfillment interface is desirable, as per FIG. 2D-2F. Once the fulfiller submits work relating to fulfillment of the task, the client interface 302 sends a message containing the relevant card, task, and/or fulfiller identifying data as well as the content of that work itself (whether text, attachments, or other data representation) as a structured URI, potentially with attachments, or a REST API call, to the server's web services layer 304, which is analyzed by the business logic for processing. In this case, at step 413 the message does include a submission of fulfillment work, so the work flow proceeds from step 413 to 414, whereupon the server saves the fulfiller's work in fulfillment work data storage 311.

The work flow then proceeds to step 415, which itself depends further on the nature of the action taken. If the user is saving but not submitting his work, for instance, there will not be a change in the card's key state on its entry in the card assignment data storage 310 (although other information, such as edit and activity timestamps may change) and the workflow will return to step 408. If the user has finalized his work relating to this call to action cycle, the workflow will instead proceed from step 415 to step 416, with a change in key state to “Completed”. In the described embodiment, “Completed” is a final state, and no further work is required to proceed from this state, so the flow proceeds from step 408 to step 409. “Completed” is a final key state, so at this point, the task is finished and its card in this fulfiller's task board may be illustrated by an arrangement similar to FIG. 2C.

In some embodiments, after a task is completed by a fulfiller and recorded in data storage, the customer may be polled or solicited for feedback regarding the quality of the work and experience. The customer may submit feedback to the server to be stored in comments and feedback data 312, which those skilled in the art will appreciate can be associated with the pertinent card assignment data, fulfiller data, or fulfillment work data by naming scheme, relation, or other indexing means. This feedback data may be used, among other things, to rate the fulfiller's performance or nonperformance. Such performance data may further be analyzed by routines in data storage, external applications, or business logic offline or in real-time to further inform future card assignments and task allocations performed by the allocation engine 305. For example, high-value tasks or high-value customers may have their tasks assigned in greater proportion or exclusivity to highly-rated fulfillers. The system may provide greater tangible or intangible rewards to highly-rated fulfillers, or simply assign greater quantities of work to highly-rated fulfillers until an equilibrium point is reached with respect to a long-term rate of satisfaction. Fulfillers may derive lead acquisition benefits from increased activity and fulfillment on the system as well. All these various benefits can serve to reduce the incidence of task abandonment and maintain a higher level of quality in fulfillment, particularly for high-value tasks as defined by the system. Feedback is best maintained as a cumulative history of fulfillment records, but weighting and scaling algorithms with respect to such historical data can be implemented in different ways with different parameters including freshness and decay, statistical regression, cumulative rankings and popularity measures, or any combination of the above as appreciated by those having skill in the art.

Expanded Card Detail

Expandable elements in the cards that can present additional task information, status information, or other descriptive information about the task described. For instance, see FIG. 2G below, where a card has been expanded to reveal a greater quantity of information regarding the task being considered. In FIGS. 2A-2C, all cards are of a uniform size in order to conserve visual space on the fulfiller's display device and to present uniformity in presentation, but this can also limit the amount of information at the fulfiller's disposal in reviewing tasks expediently. In FIG. 2G, element 228 depicts an expandable and/or re-collapsible information section which can dynamically expand to show the full user- or system-provided description of the task at hand, enabling the fulfiller or prospective fulfiller to better review tasks and make decisions.

Compound or Sequential Acceptance and Fulfillment Criteria

The embodiment described above illustrates a relatively simple design where one complete action is needed to progress from one key state to another. It should be noted that the card assignment states may consider several different types of information beyond just the key status, and that other conditions may be modeled and considered in concert as requirements for a transition from one key state to another. FIGS. 2H and 21 illustrate a modified embodiment wherein multiple, sequential conditions are required of the fulfiller in order to transition a task from the “New” column to the “Working” column.

FIG. 2H depicts a new card in this environment. The user has expanded the card to display descriptive elements in a way similar to FIG. 2G, and the card now displays two calls to action, 229 and 232. This arrangement depicts a situation where the sequential acceptance of two conditions is necessary in order to begin fulfillment work on a given task, in this case, a professional obligation to avoid conflicts of interest between different customers who may submit tasks, and then the acceptance of the task for fulfillment as described in the previous embodiment.

Call to action 229 starts greyed out, the data mapped to this card stored within card assignment data 310 and business logic 306 inform the interface and message processing such that attempts to use call to action 229 are disabled while the conditions that enforce the presence of call to action 232 are present. Call to action 232 Is, however, available for selection and maintains two options: indication of the existence of a professional conflict of interest 234, or a confirmation that no professional conflict of interest that would preclude this fulfiller from working on the task. Starting at FIG. 4B of the flow at step 411, if the fulfilled selects call to action 234, the flow proceeds to 412 and indicates rejection. When the fulfiller selects action 234, the client interface 302 sends a structure URI, REST API query, or other information transfer procedure to the server's web services layer 304. The business logic layer analyzes the request and retrieves the information relating to the submitted action, determines that it is a rejection of the task, and modifies the associated card assignment data accordingly. In response to the customer request, the server returns via its web services layer task board information retrieved from frontend resources 303 informed by card assignment data 310 and other supporting data back to the fulfiller's client interface 302, and the task is aborted for this fulfiller.

If, alternatively, the fulfiller or worker selects call to action 233, indicating that there is no professional conflict of interest that would prevent him from working on the task-fulfiller relationship mapped to this card, the client interface 302 sends a different message to the server, containing information indicating the fulfiller's intention to accept the condition of no conflict. This is represented in the work flow of FIG. 4B as proceeding from step 411 to step 412, whereupon the server's web services layer 304 receives the message, and the business logic 306 processes it. As the indicated action does not contain actual fulfillment work, step 413 passes control to step 415, which further determines that the acceptance of this condition results in a card state change (though not a key state change) that is recorded in the mapped entry in card assignment data 310 at step 416. The flow returns to step 408, which determines that not all work required to proceed from this key state is complete, as the actual acceptance of the task itself was not communicated by the previous action. The server therefore proceeds to use card fulfillment data 310 and other supporting data along with frontend resources 303 to prepare data (whether a full web page, a JSON response to an Ajax call, or other data transfer protocol) to render an updated task board on the client interface 302. The card remains in the “New” column, but its presentation changes to reflect its modified state as pre FIG. 2I, where the conflict resolution call to action is gone, but the task acceptance call to action remains as call to action 235, now enabled. At this point, the card, task, and fulfiller are in a position similar to FIG. 2A, with call to action elements 235, 236, and 237 being analogous to call to action elements 205, 206, and 207. The fulfiller can continue on to accept the task and proceed to the work of fulfillment as in the previously described embodiments.

Feedback: Worker or Fulfiller Rejection of a Task

Other, optional, or additional workflows may be inserted into the workflow as required or suggested by the circumstances, nature of the work involved, the need or desire to gather feedback, or other purposes. For instance, a fulfiller's rejection of a task in the “New” column in FIG. 2A by selecting call to action 207 may prompt the declining fulfiller with an interface requesting feedback as to the reason for rejection. This would add a step (potentially optional) after abandoning the task after step 412. This information may later be used by the allocation engine 305 or in conjunction with fulfiller data 309 or customer data 307 or task data 308 in evaluating future task assignments for priority. This will affect the work flow of FIG. 4A at steps 402 and 403 by providing additional potential inputs and data to the task matching algorithms.

Items.

Disclosed embodiments may include the following items:

Item 1. A user interface system to dynamically display prioritized tasks and other task information upon a screen, the user interface comprising:

a) the display of a task board, the task board comprising a plurality of columns, with a first column displaying one or more task cards for new tasks and a second column displaying one or more task cards for tasks in progress;

b) task cards of the first column displaying a call to action area comprising an interface to accept a review command 206 and an interface to accept a reject command 207, the task cards of the first column further comprising a display of task subject matter, a written display of time to act and a dynamic real time graphical display of time to act, the real time graphical display in the shape of a fuse box 208, the fuse box having a hollow portion that fills in as time elapses.

c) task cards of the second column comprising a written display of task subject matter, a call to action interface comprising one or more icons to select, a written display of time to complete a task and a dynamic real time graphical display of time to complete a task, the real time graphical display in the shape of a fuse box 211, the fuse box having a hollow portion that fills in as time elapses.

d) the task cards of the first column prioritized on the basis of time remaining to act, with task cards having the shortest time remaining to act placed at the top of the first column;

e) the task card of the second column prioritized on the basis of time remaining to complete a task with the task cards having the shortest time remaining to complete a task placed at the top of the second column.

Item 2. The user interface of item 1 wherein the task cards of the first column comprises a conflicts of interest interface;

Item 3. The user interface of item 1 wherein the task cards of both the first and second column include a display of customer information.

Item 4. The user interface of item 1 wherein the task cards of the first column change color based upon the time remaining to act.

Item 5. The user interface of item 1 wherein the task cards of the second column change color based upon the time remaining to complete a task.

Item 6. The user interface of item 1 wherein the assignment of priority of task cards in the first column and second column are weighted by system assigned values.

Item 7. The user interface of item 1 wherein the task board includes the display of a third column, with the third column comprising the display of task cards of completed tasks.

Item 8. The user interface of item 1 further including the use of a plurality of databases, computer processor, machine readable instructions held upon non-transitory computer readable media and nonvolatile memory.

Item 9. The user interface of item 1 further comprising a plurality of databases, computer processor, machine readable instructions held upon non-transitory computer readable media and nonvolatile memory.

What is claimed is:

1. A user interface system to dynamically display prioritized tasks and other task information upon a screen, the user interface comprising:
a) the display of a task board, the task board comprising a plurality of columns, with a first column displaying one or more task cards for new tasks and a second column displaying one or more task cards for tasks in progress;
b) task cards of the first column displaying a call to action area comprising an interface to accept a review command and an interface to accept a reject command, the task cards of the first column further comprising a display of task subject matter, a written display of time to act and a dynamic real time graphical display of time to act, the real time graphical display in the shape of a fuse box, the fuse box having a hollow portion that fills in on a real time basis as time elapses;
c) task cards of the second column comprising a written display of task subject matter, a call to action interface comprising one or more icons to select, a written display of time to complete a task and a dynamic real time graphical display of time to complete a task, the real time graphical display in the shape of a fuse box, the fuse box having a hollow portion that fills in on a real time basis as time elapses;
d) the task cards of the first column prioritized on the basis of time remaining to act, with task cards having the shortest time remaining to act placed at the top of the first column; and
e) the task cards of the second column prioritized on the basis of time remaining to complete a task with the task cards having the shortest time remaining to complete a task placed at the top of the second column.

2. The user interface of claim 1 wherein the task cards of the first column comprise a conflicts of interest interface.

3. The user interface of claim 1 wherein the task cards of both the first and second column include a display of customer information.

4. The user interface of claim 1 wherein the task cards of the first column change color based upon the time remaining to act.

5. The user interface of claim 1 wherein the task cards of the second column change color based upon the time remaining to complete a task.

6. The user interface of claim 2 wherein the assignment of priority of task cards in the first column and second column are weighted by system assigned values.

7. The user interfaces of claim 1 wherein the task board includes the display of a third column, with the third column comprising the display of task cards of completed tasks.

8. The user interface of claim 1 further including the use of a plurality of databases, a computer processor, machine readable instructions held upon non-transitory computer readable media and nonvolatile memory.

9. The user interface of claim 1 further comprising a plurality of databases, a computer processor, machine readable instructions held upon non-transitory computer readable media and nonvolatile memory.
